(19) United States
(12) Patent Application Publication
(10) Pub. No.: US 2006/0253996 A1
(43) Pub. Date: Nov. 16, 2006

(54) Hammer tacker with cutter

(76) Inventor: Rosalie Bianco, NW Lilburn, GA (US)

Correspondence Address: LAW OFFICE OF COLLEN A. BEARD, LLC, P. O. BOX 1064, DECATUR, GA, 30031-1064, US

(21) Appl. No.: 11/127,663

(22) Filed: May 12, 2005

(51) Int. Cl. B26B 11/00; B25C 5/06

(52) U.S. Cl. 7/160; 7/158; 227/133

(57) ABSTRACT

A hand tool including a hammer tacker and a cutting implement that allows a worker to tack and cut materials using a single tool.

### BACKGROUND OF THE INVENTION

The invention relates to a hand tool. More specifically the invention relates to a single hand tool incorporating both a hammer tacker and a cutting implement. The tool allows a worker to tack and cut materials using a single tool.

Hammer type tackers are well known in the prior art (see, for example, U.S. Pat. No. 6,550,660), and are generally comprised of a tack (staple) delivery head and staple magazine attached to a handle. They are operated with a hammering action which is much less tiring than the squeezing action required by lever-operated staplers. This type of tool is often used in the construction industry, such as for tacking roofing paper to roofs.

Roofing paper must be trimmed to size after it is tacked. Conventional utility knives are often used for cutting the paper, which is inconvenient because the roofer must constantly switch between the hammer tacker and the knife. When repeated many times a day, day after day, the switching becomes annoying and productivity is reduced. Moreover, there is always the risk of dropping one of the tools while switching and having it roll off of the roof.

The present invention addresses this need by providing a hammer tacker and cutter in one easy to use hand tool. Other tools have been developed that combine a hammer tacker and a cutter. For example see U.S. Pat. Nos. 5,852,840, 5,911,761, and 6,823,592. However the present tool offers advantages over these previously developed tools.

U.S. Pat. No. 5,852,840 teaches a hammer tacker having a cutting blade extending from the tacking assembly. The cutting blade is not retractable and thus presents a danger, both while the tacker portion is being used, and when the tool is not in use.

U.S. Pat. No. 5,911,761 teaches a tool that essentially replaces the handle of a hammer tacker with a utility knife. To reload staples into the tool, the staple holder is rotated away from the actuator. This cutter mechanism will not work with a hammer tacker in which the staples are loaded from the rear of the handle.

U.S. Pat. No. 6,823,592 also teaches a hammer tacker having a cutter extending from the tacking assembly. The cutter is retractable when not in use, however, the user has to take his or her hand off the handle to adjust the cutter blade.

### BRIEF DESCRIPTION OF THE DRAWINGS

FIG. 1 is a side view of the hammer tacker of the present invention.

FIG. 2 is a bottom view thereof.

FIG. 3 is a side view of the hammer tacker of the present invention showing the cutter blade retracted and the staple reloading mechanism extended.

FIG. 4 is a side view of the cutter blade housing of the hammer tacker of the present invention.

FIG. 5 is a side view of the blade in the blade slide.

FIG. 6 is a view of the inside surfaces of the blade housing plates.

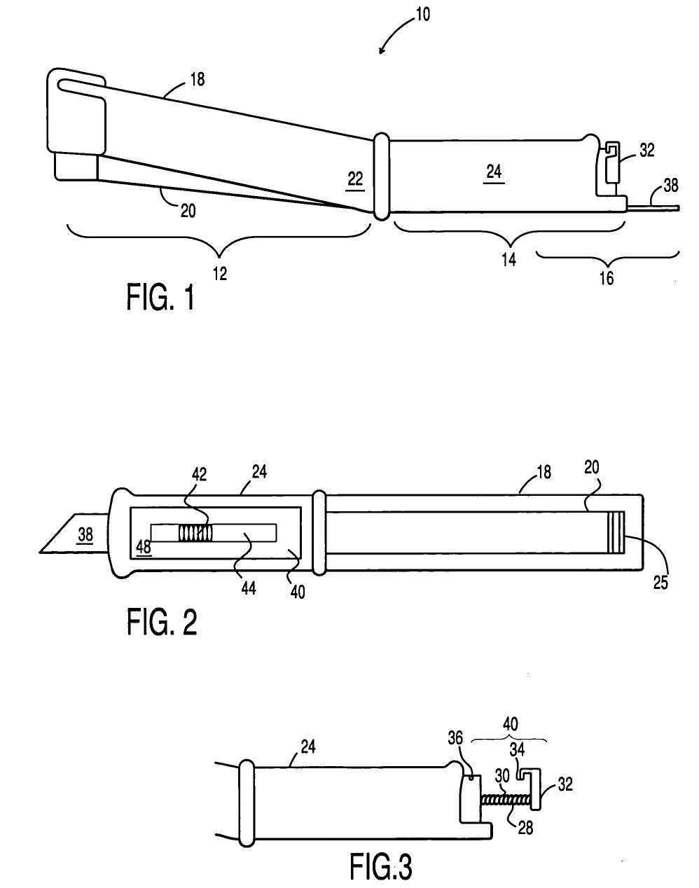

### SUMMARY OF THE INVENTION

The invention is a hand tool including a hammer tacker for fastening a material to a roof, for example, and a cutter for cutting that material before or after it is fastened. The hammer tacker portion of the hand tool is similar to prior art tackers in that it includes an actuator that melds at its rear end into a handle and a staple holder pivotally attached to the actuator. In use, the tool is grasped by the handle and swung like a hammer. The inertia of the swing depresses the actuator relative to the staple holder driving home the uncrimped staple. The hammer tacker includes a rubber hand grip that covers the hollow metal handle of the stapler so that it can be securely grasped while being swung by one hand. Staples are loaded into the staple holder by extracting a cartridge at the distal end of the tool, from the distal end of the handle.

The cutter portion of the hand tool is located on the handle portion of the tool, and the blade is retractable for safety. The cutter portion and blade thereof does not interfere with the functioning of the tacker portion, including loading the staples. To use the cutter, the user simply flips the tool, holding it by the handle but in the opposite direction, uses his or her thumb on the thumb piece actuator to extend the blade, cuts the material, and then uses his or her thumb on the actuator to retract the blade.

While described specifically for use by a roofer, the tool is useful to any person who works with sheets of material that must be stapled to an underlying structure then trimmed to the shape of the structure and/or cut free from a roll of sheet material.

### DETAILED DESCRIPTION

The improved hammer tacker with cutter hand tool 10 comprises a tacker portion 12, a handle 14, and a cutter portion 16. The tacker portion 12 can be one of several types known in the art. In the embodiment shown in the figures and described herein, the tacker portion 12 comprises an elongated upper channel member 18, with an elongated lower channel member 20 inside to the upper channel member 18 and pivotally mounted to the elongated upper channel member 18 at a rearward end thereof.

Hitting the elongated lower channel member 20 against a surface will drive the lower channel member 20 into the upper channel member 18 and effect dispensing of the staple from the dispensing means through the dispensing means tip 25.

The handle 14 is distal to the pivot point 22 and is covered by a rubber hand grip 24.

The elongated lower channel member 20 includes a dispensing means (not completely shown) mounted within the elongated lower channel member 20. Staples are loaded into the tool 10 through the rear of the handle in the same way as staples are loaded into prior art staplers. See U.S. Pat. No. 4,552,296 to Sheng, for example. Inside the handle and running up the elongated lower channel means 20 is a staple guideway (not shown). A pusher 26 cooperates with the guideway, and is inserted into the guideway so as to push the staples therein to the exit of the guideway. The pusher 26 is provided with a rod 28 enclosed by a spring 30, an inverted U-shaped block on one end (not shown), and a locking plate 32 on the other end. The locking plate includes a tab 34 which fits into a slot 36 on the end of the handle 14.

The cutter portion 16 is incorporated into the rubber hand grip 24. It includes blade 38 which extends and retracts from the blade housing 40 in response to movement of the actuator 42 within slot 44. By moving the actuator 42 forwardly and backwardly in the slot 44, the blade 38 is extended or retracted from the tool 10. Desirably the cutter portion is on the underside of the tool, as shown in the Figures, but it can be on any side.

The blade mechanism of the cutter portion can be any of several known in the art, where the blade moves in response to movement of an actuator. See, for example, U.S. Pat. Nos. 3,879,847 and 4,089,112.

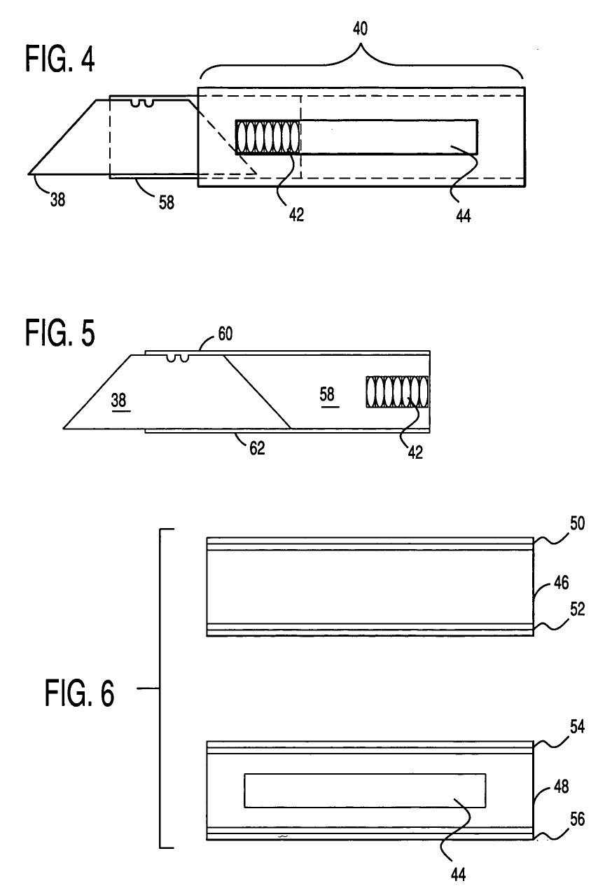

Blade housing 40 is removable from the rubber hand grip 24 so that the blade 38 can be replaced. Rubber hand grip has an indentation (not shown) into which blade housing fits. FIG. 4 illustrates the blade housing removed from the tool. Blade housing 40 includes two plates 46 and 48 (see FIG. 6) which snap together. The housing plates 46, 48 define a guide slot there between (not shown) and each housing plate 46, 48 includes guide grooves 50, 52 and 54, 56, respectively

The blade 38 is carried by blade slide 58, which is displaceably guided in the guide slot (not shown). Blade slide 58 has overturned side edges 60, 62 to hold the blade 38 securely. These side edges 60, 62 are guided in the guide grooves 50, 54 and 52, 56, respectively. Actuator 42 is attached to the blade slide 58 and extends upward through slot 44 in housing plate 48. The cutter desirably includes a locking mechanism that prevents the blade from extending unless pressure is placed on the actuator 42.

Any of various types of blades can be used in the cutter, such as the standard utility blade shown in the Figures, or a hook blade.

To use the hand tool, the operator grasps the tool by the handle and swings the hammer tacker portion to apply the fastener to the material to be fastened. He or she then flips the tool, holding it by the handle but in the opposite direction, and uses his or her thumb on the thumb piece actuator to extend the blade and cut the material, and then uses his or her thumb on the actuator to retract the blade.

Modifications and variations of the present invention will be apparent to those skilled in the art from the forgoing detailed description. All modifications and variations are intended to be encompassed by the following claims. All publications, patents, and patent applications cited herein are hereby incorporated by reference in their entirety.

What is claimed is:

1. A hand tool for attaching a material to a surface and cutting the material before or after it is attached, comprising a hammer tacker portion, a handle, and a cutter portion,
wherein the hammer tacker is of the kind having an elongated upper channel and an elongated lower channel pivotably mounted to the upper channel and wherein staples are loaded into the lower channel through a mechanism that slides out of the far end of the handle, and
wherein the handle is covered by a rubber hand grip and wherein the cutter portion is on the side of the hand grip and has a blade that is moveable between extended and retracted positions and does not interfere with loading of staples into the tool.

2. The hand tool of claim 1, wherein the cutter portion comprises a blade housing that is removable from the hand grip.

3. The hand tool of claim 1, wherein the blade is moveable in response to movement of a thumb piece actuator.

4. The hand tool of claim 1, wherein the blade of the cutter portion is replaceable.
